(19) United States
(12) Patent Application Publication
(10) Pub. No.: US 2003/0226141 A1
(43) Pub. Date: Dec. 4, 2003

(54) Advertisement data store

(76) Inventors: Genessa L. Krasnow, Seattle, WA (US); Brian J. Keller, Kenmore, WA (US); Jana Paquette, San Carlos, CA (US); Ruston Panabaker, Mountain View, CA (US)

Correspondence Address: LEE & HAYES PLLC, 421 W RIVERSIDE AVENUE SUITE 500, SPOKANE, WA, 99201

(21) Appl. No.: 10/162,832

(22) Filed: Jun. 3, 2002

(51) Int. Cl. H04N 7/16; H04H 9/00; H04N 7/025; H04N 7/10

(52) U.S. Cl. 725/9; 725/32

(57) ABSTRACT

An advertisement data store maintains advertisements that have been displayed for viewing and/or information corresponding to the displayed advertisements. The advertisement data store provides advertisers with an advertising model to selectively reach potential customers and clients, and provides viewers with additional information about a particular product and/or service after having viewed an advertisement of interest. A viewer can reference the information maintained in the advertisement data store without interrupting a current television program and without missing other advertisements that may be of interest to the viewer.

### TECHNICAL FIELD

This invention relates to television entertainment architectures and, in particular, to an advertisement data store.

### BACKGROUND

Interactive television combines conventional television with interactive content to provide a television-based entertainment and information system that integrates television viewing with the interactivity of a personal computer. Programming for an interactive television system can include graphics and interactive content being broadcast for display with the conventional video content of a television-based system. The interactive content can provide redirection and access to Web (World Wide Web) sites, electronic mail, and chat applications while viewing television programming, and can provide access to additional information that is not necessarily related to any television program such as a schedule of local events around town.

Conventional television advertising generates revenue to support television programming broadcasts and is a primary medium used by many companies and advertisers to communicate a product or service message to a large viewing audience. However, with traditional television advertising, it is difficult to target specific viewers and maintain viewer interest in a particular product or service with a typical thirty-second commercial. Interactive television incorporates data advertising which has also developed into a popular medium to reach a large advertising audience. Additional advertising information, such as graphics and images, can be presented to viewers during broadcast of a conventional television advertisement.

Broadcasting interactive advertisements that redirect a viewer away from current broadcast programming to obtain additional information from a particular advertiser creates potential conflicts for both the viewer and advertisers. Although a viewer may see an advertisement for a product or service of interest, the viewer may not want to be redirected away from a current television program, and may forget about the advertisement or lose interest in obtaining additional information about the advertised product or service by the time the television program is over. Further, one advertiser's message will not be seen by a viewer who has been directed away from current programming to obtain additional information about another advertiser's message.

Accordingly, for interactive television-based entertainment and information systems, there is a need for techniques to provide viewers with an option to obtain additional information corresponding to an advertisement that is of interest to them without interruption to current programming, and not at the expense of another advertiser's effort to communicate a product or service message to the same viewer group.

### SUMMARY

An advertisement data store maintains advertisements that have been displayed for viewing during an interactive television broadcast and when a user requests Web-based information. Additionally, the advertisement data store maintains information corresponding to the displayed advertisements, such as video content, audio content, an advertising image, an interactive advertisement, and/or any information or data stored in an electronic format. The advertisement data store provides advertisers with an advertising model to selectively reach potential customers and clients, and provides viewers with additional information about a particular product and/or service after having viewed an advertisement of interest. A viewer can reference the information maintained in the advertisement data store without interrupting a current television program and without missing other advertisements that may be of interest to the viewer.

### BRIEF DESCRIPTION OF THE DRAWINGS

The same numbers are used throughout the drawings to reference like features and components.

FIG. 1 illustrates an exemplary system architecture in which an advertisement data store can be implemented.

FIG. 2 illustrates of an example client device, a television, and various input devices that interact with the client device.

FIG. 3 illustrates an exemplary advertisement data store system.

FIG. 4 illustrates an exemplary advertisement data store system.

FIG. 5 illustrates an exemplary graphical user interface for an advertisement data store system.

FIG. 6 is a flow diagram that illustrates a method for an advertisement data store system.

### DETAILED DESCRIPTION

An advertisement data store system is described that maintains advertisements having been displayed for viewing and/or information corresponding to the displayed advertisements. Advertisement information corresponding to a particular advertisement is stored in an advertisement data store when the advertisement is displayed for viewing as video content, interactive content, and/or in conjunction with video content, such as during a commercial break of a television program, or as a banner advertisement displayed while the broadcast television content is also displayed. In a digital video recording system, an advertisement data store can be implemented to allow a viewer to skip over commercials and advertisements, yet store the commercials and advertisements for future reference.

The advertisement information is maintained in the advertisement data store and is available to the viewer after a television program has ended or at any point during a broadcast of the television program. This provides a new technique for advertising and making advertisements and information corresponding to the advertisements available to a viewer. A viewer can review an advertisement of interest seen during a television program, and can obtain more information about the advertised product or service, without interrupting the television program and without missing other advertisements that may be of interest to the viewer.

Further, an advertisement data store system provides advertisers a “second chance” to have their advertisements viewed by a large audience. Thus, it may be preferable to have an advertisement or commercial broadcast only once during a two-hour movie, for example, rather than spending additional advertising revenue to have the same advertisement or commercial broadcast twice during the same defined time period.

The following discussion is directed to television-based entertainment and information systems, such as interactive TV networks, cable networks that utilize electronic program guides, and Web-enabled TV networks. Client devices in such systems range from full-resource clients with substantial memory and processing resources, such as TV-enabled personal computers and TV recorders equipped with hard-disks, to low-resource clients with limited memory and/or processing resources, such as traditional set-top boxes. While aspects of the described systems and methods can be used in any of these systems and for any types of client devices, they are described in the context of the following exemplary environment.

Exemplary System Architecture

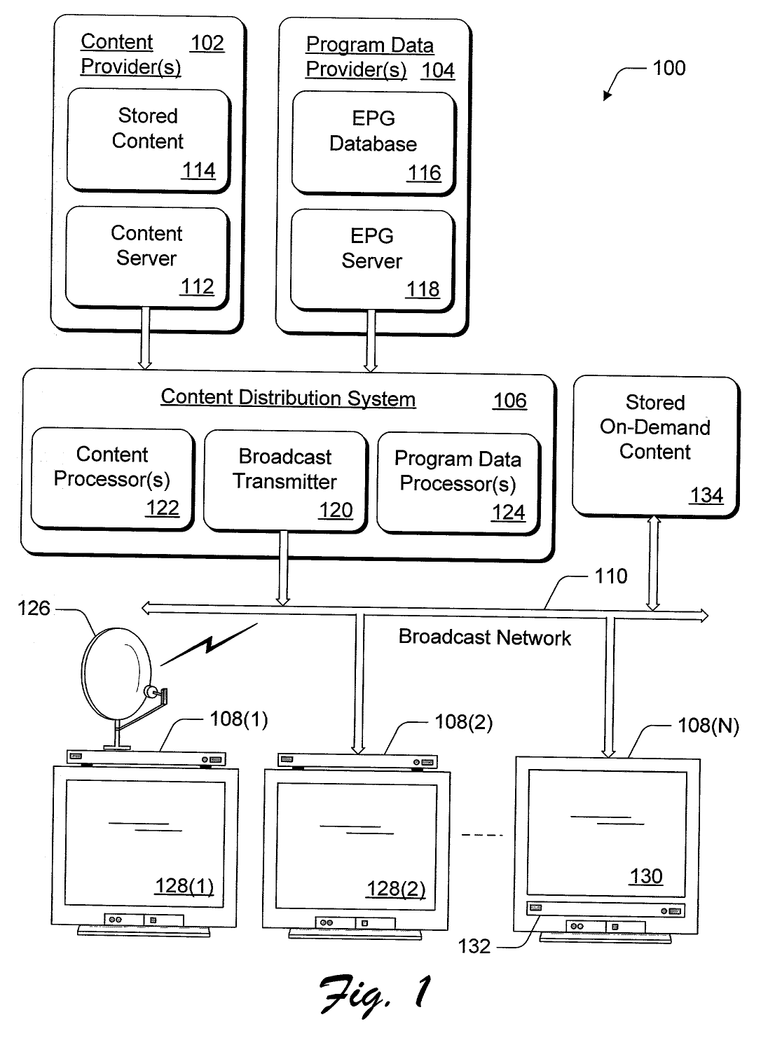

FIG. 1 illustrates an exemplary television entertainment system 100 that is an architecture in which an advertisement data store may be implemented. System 100 facilitates distribution of content and program data to multiple viewers, and facilitates an advertisement data store that maintains displayed advertisements and/or information corresponding to displayed advertisements for viewer reference. The system 100 includes one or more content providers 102, one or more program data providers 104, a content distribution system 106, and multiple client devices 108(1), 108(2), . . . , 108(N) coupled to the content distribution system 106 via a broadcast network 110.

Content provider 102 includes a content server 112 and stored content 114, such as movies, television programs, commercials, advertisement information, music, and similar audio and/or video content. Content server 112 controls distribution of the stored content 114 from content provider 102 to the content distribution system 106. Additionally, content server 102 controls distribution of live content (e.g., content that was not previously stored, such as live feeds) and/or content stored at other locations to the content distribution system 106. Program data provider 104 includes an electronic program guide (EPG) database 116 and an EPG server 118. The EPG database 116 stores electronic files of program data which is used to generate an electronic program guide (or, “program guide”). Program data (or, “EPG data”) includes program titles, ratings, characters, descriptions, actor names, station identifiers, channel identifiers, schedule information, and so on.

The EPG server 118 processes the program data prior to distribution to generate a published version of the program data which contains programming information for all channels for one or more days. The processing may involve any number of techniques to reduce, modify, or enhance the program data. Such processes might include selection of content, content compression, format modification, and the like. The EPG server 118 controls distribution of the published version of the program data from program data provider 104 to the content distribution system 106 using, for example, a file transfer protocol (FTP) over a TCP/IP network (e.g., Internet, UNIX, etc.). Further, the published version of the program data can be transmitted from program data provider 104 via a satellite directly to a client device 108.

Content distribution system 106 includes a broadcast transmitter 120, one or more content processors 122, and one or more program data processors 124. Broadcast transmitter 120 broadcasts signals, such as cable television signals, across broadcast network 110. Broadcast network 110 can include a cable television network, RF, microwave, satellite, and/or data network, such as the Internet, and may also include wired or wireless media using any broadcast format or broadcast protocol. Additionally, broadcast network 110 can be any type of network, using any type of network topology and any network communication protocol, and can be represented or otherwise implemented as a combination of two or more networks.

A content processor 122 processes the content received from content provider 102 prior to transmitting the content across broadcast network 110. Similarly, a program data processor 124 processes the program data received from program data provider 104 prior to transmitting the program data across broadcast network 110. A particular content processor 122 may encode, or otherwise process, the received content into a format that is understood by the multiple client devices 108(1), 108(2), . . . , 108(N) coupled to broadcast network 110. Although FIG. 1 shows a single content provider 102, a single program data provider 104, and a single content distribution system 106, exemplary system 100 can include any number of content providers and/or program data providers coupled to any number of content distribution systems.

Content distribution system 106 is representative of a headend service that provides EPG data, as well as content, to multiple subscribers. Each content distribution system 106 may receive a slightly different version of the program data that takes into account different programming preferences and lineups. The EPG server 118 creates different versions of EPG data (e.g., different versions of a program guide) that include those channels of relevance to respective headend services, and the content distribution system 106 transmits the EPG data to the multiple client devices 108(1), 108(2), . . . , 108(N). In one implementation, for example, content distribution system 106 utilizes a carousel file system to repeatedly broadcast the EPG data over an out-of-band (OOB) channel to the client devices 108.

Client devices 108 can be implemented in a number of ways. For example, a client device 108(1) receives broadcast content from a satellite-based transmitter via a satellite dish 126. Client device 108(1) is also referred to as a set-top box or a satellite receiving device. Client device 108(1) is coupled to a television 128(1) for presenting the content received by the client device (e.g., audio data and video data), as well as a graphical user interface. A particular client device 108 can be coupled to any number of televisions 128 and/or similar devices that can be implemented to display or otherwise render content. Similarly, any number of client devices 108 can be coupled to a single television 128.

Client device 108(2) is also coupled to receive broadcast content from broadcast network 110 and provide the received content to associated television 128(2). Client device 108(N) is an example of a combination television 130 and integrated set-top box 132. In this example, the various components and functionality of the set-top box are integrated into the television, rather than using two separate devices. The set-top box integrated into the television can receive broadcast signals via a satellite dish (similar to satellite dish 126) and/or via broadcast network 110. In alternate implementations, client devices 108 may receive broadcast signals via the Internet or any other broadcast medium.

Each client device 108 runs an electronic program guide (EPG) application that utilizes the program data. An EPG application enables a television viewer to navigate through an onscreen program guide and locate television shows and other broadcast content of interest to the viewer. With an EPG application, the television viewer can look at schedules of current and future programming, set reminders for upcoming programs, and/or enter instructions to record one or more television shows.

The exemplary system 100 also includes stored on-demand content 134, such as Video On-Demand (VOD) movie content. The stored on-demand content can be viewed with a television 128 via a client device 108 through an onscreen movie guide, for example, and a viewer can enter instructions to stream a particular movie, or other stored content, down to a corresponding client device 108.

Exemplary Client Device

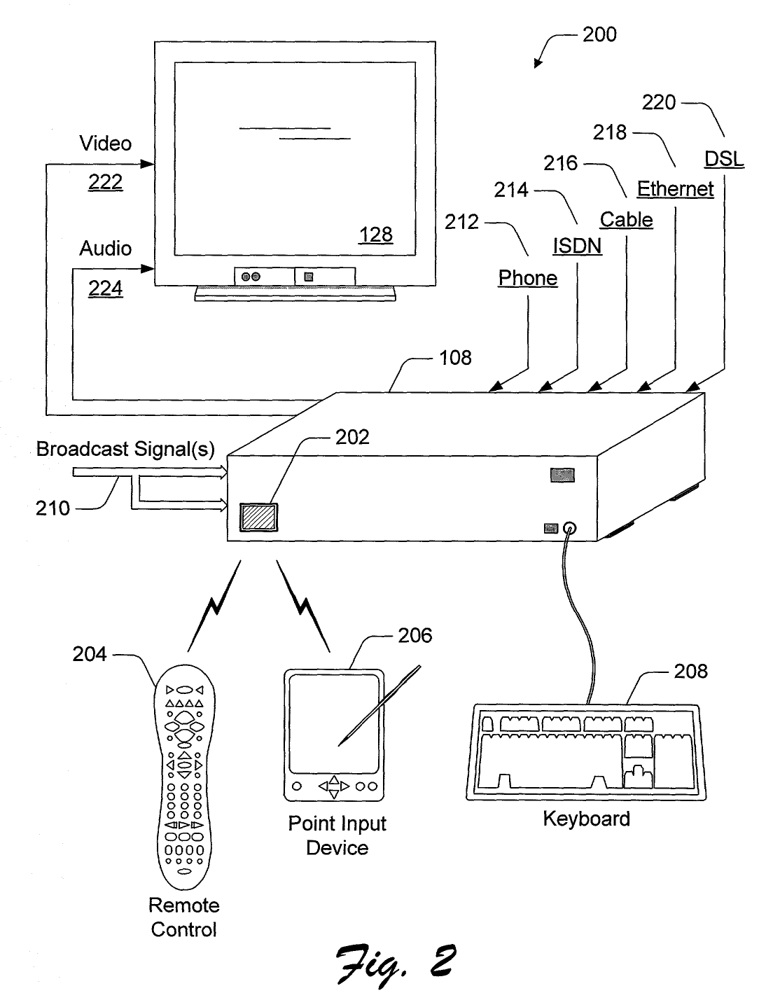

FIG. 2 illustrates an exemplary implementation 200 of a client device 108 shown as a standalone unit that connects to a television 128. Client device 108 can be implemented in any number of embodiments, including as a set-top box, a satellite receiver, a TV recorder with a hard disk, a digital video record (DVR) and playback system, a game console, an information appliance, and so forth.

Client device 108 includes a wireless port 202, such as an infrared (IR), 802.11, or Bluetooth wireless port, for receiving wireless communications from a remote control device 204, a handheld input device 206, or any other wireless device, such as a wireless keyboard. Handheld input device 206 can be a personal digital assistant (PDA), handheld computer, wireless phone, or the like. Additionally, a wired keyboard 208 can be coupled to communicate with client device 108. In alternate embodiments, remote control device 204, handheld device 206, and/or keyboard 208 may use an RF communication link or other mode of transmission to communicate with client device 108.

Client device 108 receives one or more broadcast signals 210 from one or more broadcast sources, such as from a satellite or from a broadcast network, such as broadcast network 110 (FIG. 1). Client device 108 includes hardware and/or software for receiving and decoding a broadcast signal 210, such as an NTSC, PAL, SECAM or other TV system video signal. Client device 108 also includes hardware and/or software for providing the user with a graphical user interface by which the user can, for example, access various network services, configure client device 108, and perform other functions.

Client device 108 can communicate with other devices via one or more connections including an 802.11 wireless transport via wireless connection 202, a conventional telephone line 212, an ISDN link 214, a cable link 216, an Ethernet link 218, a DSL link 220, and the like. Client device 108 may use any one or more of the various communication links 202 and 212-220 at a particular instant to communicate with any number of other devices.

Client device 108 generates video signal(s) 222 and audio signal(s) 224, both of which are communicated to television 128. The video signals and audio signals can be communicated from client device 108 to television 128 via an RF (radio frequency) link, S-video link, composite video link, component video link, or other communication link. Although not shown in FIG. 2, client device 108 may include one or more lights or other indicators identifying the current status of the device. Additionally, the client device may include one or more control buttons, switches, or other selectable controls for controlling operation of the device.

Exemplary Advertisement Data Store Systems

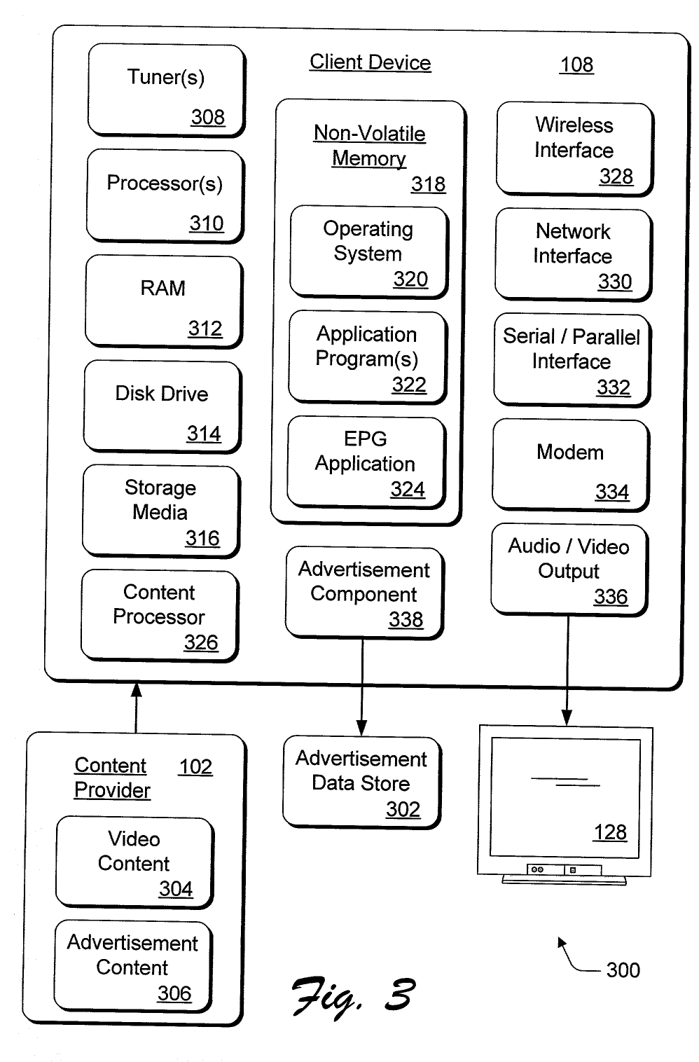

FIG. 3 illustrates an exemplary advertisement data store system 300 that includes an advertisement data store 302 and selected components of television system 100, such as a content provider 102 and an exemplary client device 108 as shown in FIGS. 1 and 2. Client device 108 receives video content 304 and advertisement content 306 from content provider 102, such as a network operator, broadcast service provider, and the like. The received video content 304 and advertisement content 306 is processed for display in client device 108, and the content is communicated to a display device, such as television 128, which is connected to client device 108 to receive and display the content for viewing.

Advertisement data store 302 maintains the advertisements that are displayed for viewing and/or information corresponding to the displayed advertisements for future reference and availability. Although shown as an independent component of system 300, advertisement data store 302 can also be implemented as a memory component of content provider 102 or as a memory component of client device 108. An advertisement, such as a broadcast commercial, can be made available in the advertisement data store 302 by using SMPTE DDE-1 (Society of Motion Picture and Television Engineers dynamic data exchange) triggers or techniques, or by using private data sections of an MPEG broadcast signal to specify metadata related to the commercial advertisement. Further, content provider 102, such as a network operator, can communicate metadata about advertisements that will be broadcast directly to the advertisement data store 302 via any number of data transport mechanisms.

Client device 108 includes one or more tuners 308 which are representative of one or more in-band tuners that tune to various frequencies or channels to receive television signals, as well as an out-of-band tuner that tunes to the broadcast channel over which the EPG data is broadcast to client device 108. Client device 108 also includes one or more processors 310 which process various instructions to control the operation of client device 108 and to communicate with other electronic and computing devices.

Client device 108 can be implemented with one or more memory components, examples of which include a random access memory (RAM) 312, a disk drive 314, mass storage media 316, and a non-volatile memory 318 (e.g., ROM, Flash, EPROM, EEPROM, etc.). The memory components (e.g., RAM 312, disk drive 314, storage media 316, and non-volatile memory 318) store various information and/or data such as received content, EPG data, configuration information for client device 108, and/or graphical user interface information.

Alternative implementations of client device 108 can include a range of processing and memory capabilities, and may include more or fewer types of memory components than those illustrated in FIG. 3. For example, full-resource clients can be implemented with substantial memory and processing resources, including the disk drive 314 to store content for replay by the viewer. Low-resource clients, however, may have limited processing and memory capabilities, such as a limited amount of RAM 312, no disk drive 314, and limited processing capabilities of a processor 310.

An operating system 320 and one or more application programs 322 may be stored in non-volatile memory 318 and executed on a processor 310 to provide a runtime environment. A runtime environment facilitates extensibility of client device 108 by allowing various interfaces to be defined that, in turn, allow application programs 322 to interact with client device 108. In the illustrated example, an EPG application 324 is stored in memory 318 to operate on the EPG data and generate a program guide. The application programs 322 that may be implemented in client device 108 can include a browser to browse the Web (e.g., “World Wide Web”), an email program to facilitate electronic mail, and so on. Client device 108 can also include other components pertaining to a television entertainment system which are not illustrated in this example. For instance, client device 108 can include a user interface application and user interface lights, buttons, controls, and the like to facilitate viewer interaction with the device.

Client device 108 also includes a content processor 326 to process a broadcast video signal, such as an NTSC, PAL, SECAM, or other TV system video signal. Content processor 326 can also include a video decoder and/or additional processors to receive, decode, and/or process video content 304 and advertisement content 306 received from content provider 102. For example, content processor 326 may include an MP3 or MPEG-2 (Moving Pictures Experts Group) decoder that decodes MPEG-encoded video and advertisement content. MPEG-2 supports a variety of audio/video formats, including legacy TV, HDTV (high-definition television), DVD (digital versatile disc), and five-channel surround sound.

Typically, video content 304 and advertisement content 306 includes video data and audio data that corresponds to the video data. Content processor 326 generates video and/or display content that is formatted for display on display device 128, and generates decoded audio data that is formatted for broadcast by a broadcast device, such as one or more speakers (not shown) in display device 128. Content processor 326 can include a display controller (not shown) that processes the video and/or display content to display corresponding images on display device 128. A display controller can include a microcontroller, integrated circuit, and/or similar video processing component to process the images. It is to be appreciated that the systems and methods described herein can be implemented for any type of encoding format as well as for data and/or content streams that are not encoded. Further, the systems and methods can be implemented for any digital audio or video medium rendered with any solid state or digital device, such as an MP-3 player.

Client device 108 further includes a wireless interface 328, a network interface 330, a serial and/or parallel interface 332, and a modem 334. Wireless interface 328 allows client device 108 to receive input commands and other information from a user-operated input device, such as from a remote control device or from another IR, Bluetooth, or similar RF input device.

Network interface 330 and serial and/or parallel interface 332 allows client device 108 to interact and communicate with other electronic and computing devices via various communication links. Although not shown, client device 108 may also include other types of data communication interfaces to communicate with other devices. Modem 334 facilitates client device 108 communication with other electronic and computing devices via a conventional telephone line.

Client device 108 also includes an audio and/or video output 336 that provides signals to television 128 or to other devices that process and/or display, or otherwise render, the audio and video data. Although shown separately, some of the components of client device 108 may be implemented in an application specific integrated circuit (ASIC). Additionally, a system bus (not shown) typically connects the various components within client device 108. A system bus can be implemented as one or more of any of several types of bus structures, including a memory bus or memory controller, a peripheral bus, an accelerated graphics port, or a local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Client device 108 includes an advertisement component 338 which can be implemented as a software component, a hardware component, or a combination of both hardware and software. As a software component, advertisement component 338 can be implemented to execute on a processor 310 and can be stored in non-volatile memory 318. Advertisement component 338 can be configured to perform several functions of an advertisement data store implementation. For example, advertisement component 338 recognizes advertisement content 306 that is processed for display as a video commercial, banner advertisement, and/or still image, and communicates the displayed advertisement content and/or additional information corresponding to the displayed advertisement to the advertisement data store 302.

Further, for an interactive advertisement displayed on display device 128, advertisement component 338 can be implemented to receive a viewer-input to a selectable control of the interactive advertisement which, when selected, initiates advertisement component 338 to store the advertisement content and/or additional information corresponding to the advertisement in the advertisement data store 302. Advertisement component 338 receives viewer selections as control inputs, such as from viewer-operated remote control device 204, handheld device 206, and/or keyboard 208 (FIG. 2). The control commands may be input via an RF, IR, Bluetooth, or similar communication link or other mode of transmission to communicate with advertisement component 338.

Advertisement component 338 can categorize the information corresponding to displayed advertisements maintained in the advertisement data store 302 by the type of product advertised, the type of service advertised, by the most recently displayed advertisements, by viewer-defined selections, such as selected favorites or favorite categories, and/or by any other type of categorizing criteria. Advertisement component 338 can also be implemented to receive a login request from a viewer, process the login request, and categorize the advertisement information according to a viewer-defined profile. Accordingly, the advertisement information stored in advertisement data store 302 can be targeted for a specific user, or users, based on any number of identity and/or authentication schemes.

Further, advertisement component 338 can be implemented to track, or otherwise log, which of the advertisements or information corresponding to the displayed advertisements is selected for review by a viewer. Advertisement component 338 can also delete the advertisement information after a defined duration, such as after a number of days, weeks, or any other type of duration basis. Alternatively, the advertisement information can be deleted after having been reviewed by a viewer or when the hard disk, or a portion of the hard disk, in a digital video recorder becomes full with stored advertisements.

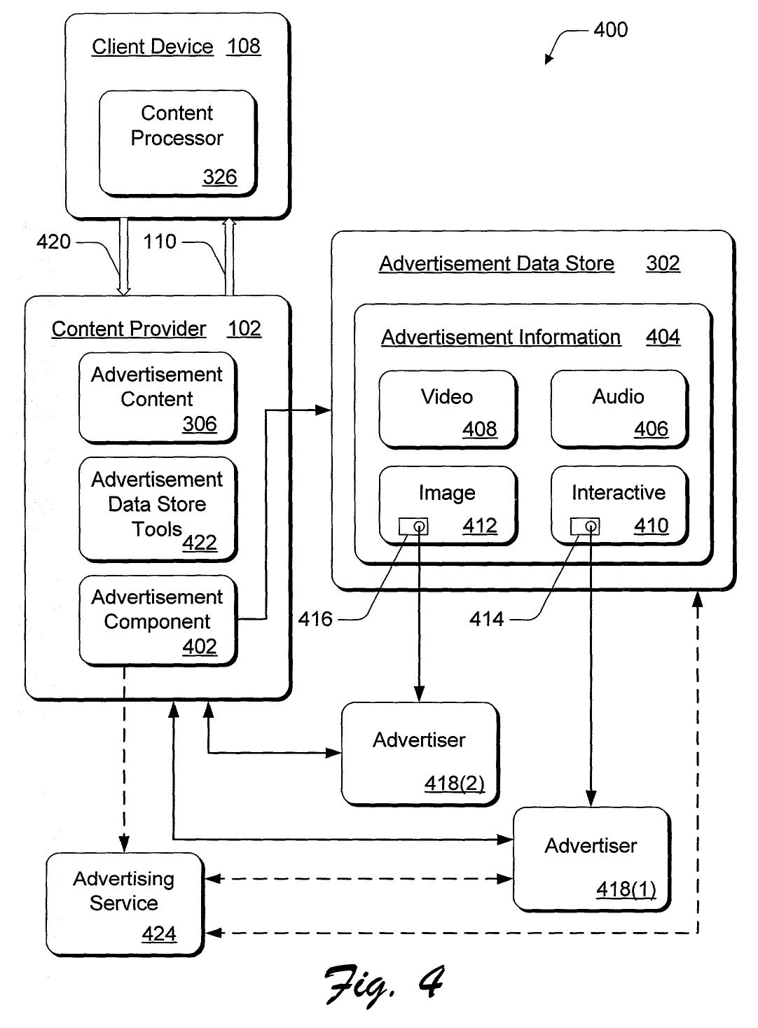

FIG. 4 illustrates an advertisement data store system 400 that includes selected components of system 300 (FIG. 3), such as a content provider 102 (e.g., a network operator or a broadcast service provider), a client device 108, and an advertisement data store 302. Client device 108 includes a content processor 326 as described above with reference to FIG. 3. In system 400, content provider 102 includes advertisement content 306 and an advertisement component 402 which can be configured to perform the several functions of an advertisement data store implementation as described above with reference to FIG. 3.

Advertisement data store 302 maintains advertisement information 404 that corresponds to one or more advertisements having been displayed on a display device for viewing. The advertisement information 404 can include any information or data stored in an electronic format, such as audio content 406, video content 408, an interactive advertisement 410, such as an HTML page, and/or an advertising image 412, such as a JPEG image that advertises a product or service.

While the audio content 406 and the video content 408 is typically broadcast content, audio content 406 and video content 408 can be streaming content, such as a typical thirty-second commercial or any other video information corresponding to a displayed advertisement. Additionally, streaming audio and/or video can be incorporated into the interactive advertisement 410, stored locally at client device 108 with a digital video recording (DVR) system, and/or delivered to client device 108 using Video On-Demand (VOD) techniques to retrieve stored on-demand advertisement information. Although not shown, advertisement information 404 may also include flash animation content and/or advertisement information that is a combination of one or more of the described advertisement information types.

Interactive advertisement 410 and advertising image 412 each include an example of a selectable control 414 and 416, respectively. A selectable control links to additional information corresponding to advertisement information maintained in advertisement data store 302. For example, selectable control 414, when selected, links to additional information maintained by an advertiser 418(1). The additional information can correspond to the product or service represented by interactive advertisement 410 and the additional information can include any form of electronic data stored, maintained, or otherwise accessible from advertiser 418(1). The advertisement component 402 can track when a selectable control 414 in the advertisement data store 302 is selected by a viewer and automatically generate a billing event to charge the advertiser 418(1) for the service.

Similarly, selectable control 416, when selected, links to additional information maintained by an advertiser 418(2). The additional information can correspond to the product or service represented by image 412 and the additional information can include any form of electronic data stored, maintained, or otherwise accessible from advertiser 418(2). Although only two advertisers 418(1) and 418(2) are shown in advertisement data store system 400, it is to be appreciated that advertisement information 404 can reference, or otherwise link to, any number of advertisers having additional information corresponding to advertisement information maintained in advertisement data store 302.

Content provider 102, such as a network operator, maintains advertisement content 306 which is received from any number of advertisers, such as from advertisers 418(1) and 418(2). The advertisement content 306 is provided, or otherwise communicated, to client device 108 over a broadcast network, such as broadcast network 110 (FIG. 1). The content processor 326 in client device 108 processes the advertisement content 306 corresponding to a particular broadcast channel for display. Typically, a viewer selects which broadcast channel to view when watching television, for example. Additionally, a viewer can be provided the option to select which broadcast advertisements, and associated information, will be stored in their advertisement data store. The broadcast display can include an overlaid selectable control that the viewer selects to include an advertisement in the advertisement data store 302.

Client device 108 communicates feedback over a back channel 420 to content provider 102 as to which advertisements are displayed, or processed for display. Back channel 420 can be implemented as an Internet connection using a modem connection and conventional telephone line 212, for example. The advertisement component 402 of content provider 102 then stores the displayed advertisements in advertisement data store 302. Additionally, advertisement component 402 can obtain other advertising information corresponding to a displayed advertisement from an advertiser, such as from advertisers 418(1) and 418(2), and store the additional advertising information in advertisement data store 302.

For example, if an advertisement for a movie is displayed for viewing, or if a viewer selects or otherwise interacts with a movie trailer, advertisement component 402 can store the movie advertisement or trailer in the advertisement data store 302. Additionally, or alternatively, the advertisement component 402 can obtain a full-length movie trailer corresponding to the shorter movie advertisement from an advertiser 418 and store the full-length movie trailer in the advertisement data store 302 instead of the shorter movie advertisement. This allows an advertiser to communicate a longer and more detailed advertisement to a potential consumer, as well as provides the viewer with more and different information that may be of interest to the viewer. For example, if a viewer selects to have a advertisement for a car stored in the advertisement data store 302, the advertisement component 402 can also store other information associated with the car advertisement, such as information about other vehicles offered by the same manufacturer, where the nearest auto dealer is located, and the like. It should be noted that any additional advertising information can be maintained locally with content provider 102 or obtained after receiving the feedback information from client device 108 via back channel 420 as to which advertisements have been displayed.

In addition to the content provider 102 obtaining additional and associated advertisement information from advertisers 418 for broadcast commercials and the like, content provider 102 includes advertisement data store tools 422 that can be implemented as automated and/or interactive tools to manage the advertisement information 404 in the advertisement data store 302. The advertisement data store tools 422 can include such tools to categorize the advertisement information, edit associated metadata, and graphics tools to generate an advertisement and specify the metadata. With the advertisement data store tools 422, the content provider 102 (e.g., a network operator) can populate the advertisement data store 302 with advertisement information 404, to include advertisement information not previously broadcast or displayed for viewing, and manage the information. The advertisement component 402 can request advertisement information from advertisers 418 to generate and present advertisement information 404 to target advertising at particular demographics associated with one or more advertisement data stores 302.

As described above with reference to FIG. 3, advertisement data store 302 can also be implemented as a component of content provider 102 or as a component of client device 108. If advertisement data store 302 is implemented as a component of client device 108, content provider 102 periodically communicates advertisement information 404 and interface configuration information to client device 108.

An alternative implementation of the advertisement data store system 400 includes an advertising service 424 that can be configured to implement many of the functions described with reference to advertisement component 402. For example, advertising service 424 can receive the information from client device 108 as to which advertisements have been displayed, or processed for display, communicate with an advertiser to obtain a displayed advertisement or additional information corresponding to the displayed advertisement, and store advertisement information 404 in the advertisement data store 302. Further, advertising service 424 can track advertisement history information for a particular viewer associated with client device 108, and communicate the advertisement history information to an advertiser.

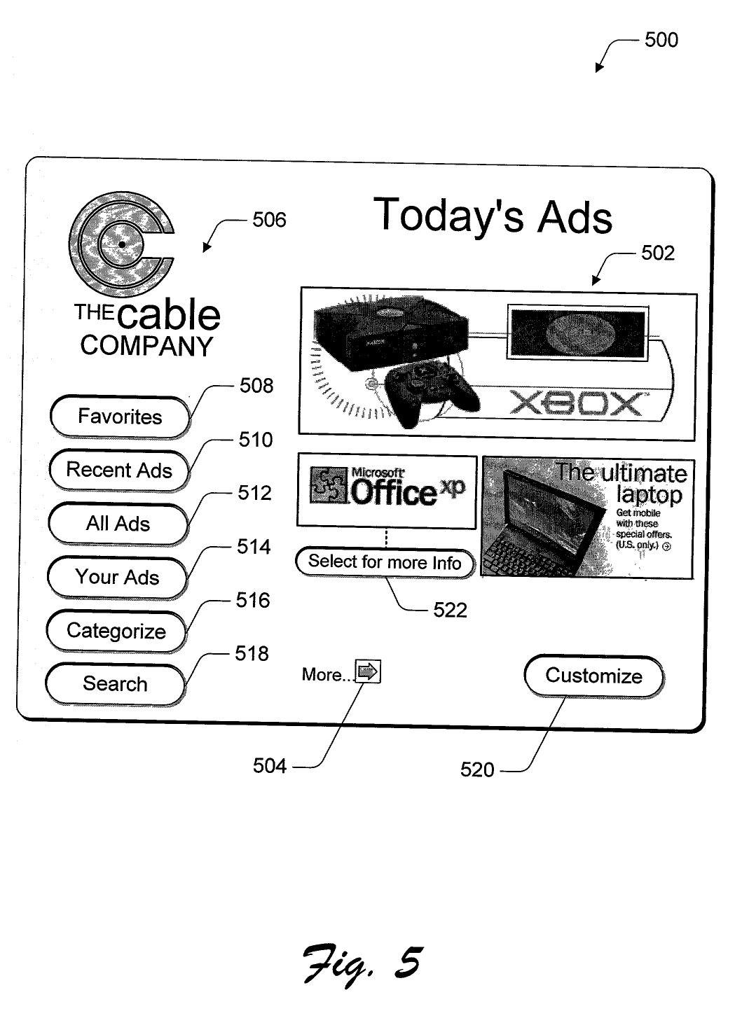

FIG. 5 illustrates an exemplary graphical user interface 500 that displays advertisement information 502 maintained in an advertisement data store. The user interface 500 also includes various selectable controls for optional viewer-defined displays of the advertisement information. User interface 500 can be generated with a user interface application implemented as an application program 322 of client device 108 (FIG. 3), for example.

User interface 500 can include any type of information and any number of selectable controls, as well as control 504 to view additional information and controls on additional pages of the user interface. In this example, user interface 500 includes a content provider identifier 506, a “favorites” selectable control 508, a “recent ads” selectable control 510, an “all ads” selectable control 512, a “your ads” selectable control 514, a “categorize” selectable control 516, a “search” selectable control 518, and a “customize” selectable control 520. Each selectable control 508 through 520, when selected by a viewer for example, performs one or more functions to display the advertisement information maintained in an advertisement data store.

When control 508 is selected, a viewer's designated “favorites” or pre-selected advertisements are displayed for viewing in user interface 500. When control 510 is selected, the most recent advertisements and/or corresponding information stored in the advertisement data store are displayed for viewing. For example, advertisement information 502 corresponds to three advertisements recently displayed via a client device 108. When control 512 is selected, all of the advertisements and/or corresponding information is displayed for viewing. These can be presented as a textual list of available advertisement information, for example, and across several pages of user interface 500.

When a viewer logs in to an advertisement data store to review previously displayed advertisements and/or additional corresponding information, the advertisements and information associated with the viewer is displayed when control 514 is selected. When control 516 is selected, the advertisements and corresponding information can be categorized by the type of product advertised, the type of service advertised, by the most recently displayed advertisements, by viewer-defined selections, and/or by any other type of categorizing criteria. Similarly, when control 518 is selected, a viewer can search for an advertisement that the viewer may have previously seen and/or that is of interest to the viewer. The search criteria can include the category information, such as the type of product advertised, the type of service advertised, or any other type of searching criteria. Additionally, a viewer can customize the user interface 500 and the display of advertisement information when selecting control 520.

With an advertisement data store, advertisers can target a specific viewer or group of viewers with interactive and viewer-centric advertising. Further, viewers can find advertisements that they have previously seen, as well as inquire and receive additional information directly from a specific advertiser. For example, a viewer can select an advertisement associated selectable control 522 to obtain more information about a product or service, order and/or receive a free sample of a product, shop directly with an advertiser, print coupons, and/or research products and services of interest to them. An advertisement data store system enhances and redefines impulse and window shopping, provides advertisers with an improved advertising model to selectively reach potential customers and clients, and provides viewers a way to easily follow-up with an advertiser after having viewed an advertisement of interest.

Further, an advertisement data store system enables a content provider with new business method and revenue generating possibilities. For example, revenue can be generated by displaying a particular advertisement (or corresponding information) on the front page of graphical user interface 500, by placing a particular advertiser at the top, or at the front, of a product or service list, by maintaining advertisement information for a particular advertiser in an advertisement data store for a longer duration to thereby increase the potential exposure to more viewers, and by any number of other business method and/or business logic applications.

In one implementation, an advertisement data store can be implemented with an XML data schema for describing an advertisement, information corresponding to the advertisement, searchable keywords, the location of the advertisement, selectable control linking information, and the like. In a broadcast television-entertainment system, the advertisement data store can also be implemented with a standard protocol for broadcasting advertisements that are then available in any compliant client device application.

Methods for an Advertisement Data Store

Methods for an advertisement data store may be described in the general context of computer-executable instructions. Generally, computer-executable instructions include routines, programs, objects, components, data structures, and the like that perform particular functions or implement particular abstract data types. Methods for an advertisement data store may also be practiced in distributed computing environments where functions are performed by remote processing devices that are linked through a communications network. In a distributed computing environment, computer-executable instructions may be located in both local and remote computer storage media, including memory storage devices.

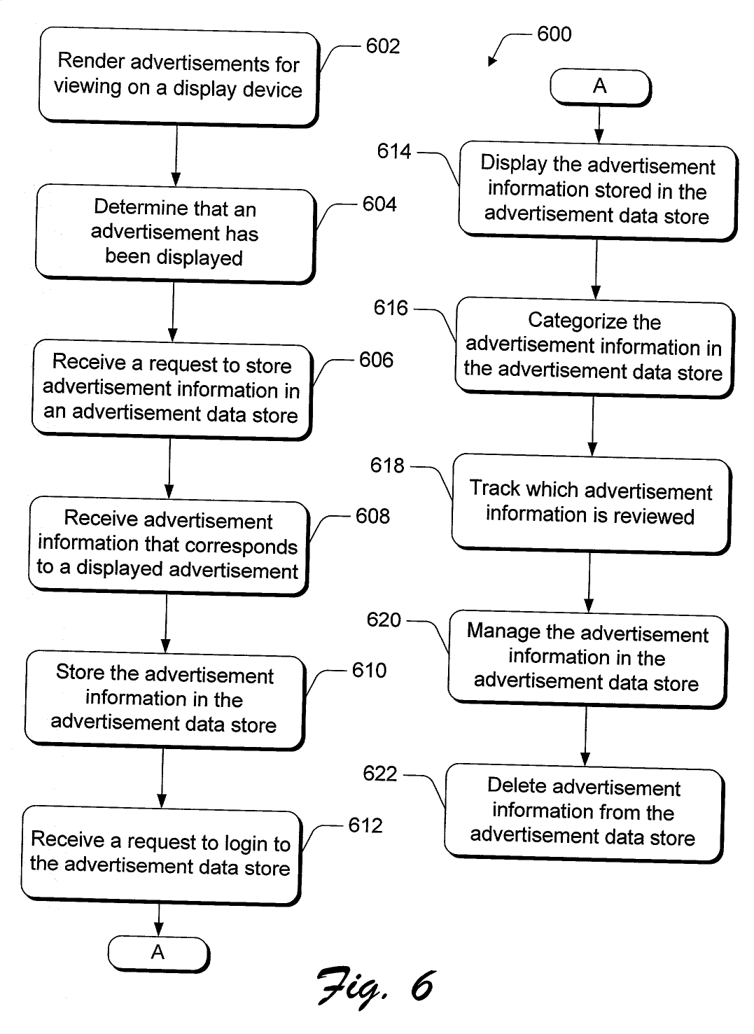

FIG. 6 illustrates a method 600 for an advertisement data store system. The order in which the method is described is not intended to be construed as a limitation, and any number of the described method blocks can be combined in any order to implement the method. Furthermore, the method can be implemented in any suitable hardware, software, firmware, or combination thereof.

At block 602, advertisements are rendered for viewing on a display device. For example, client device 108 processes received advertisement content 306 and communicates the content to television 128 to display the advertisements for viewing. Rendering the advertisements includes displaying an advertisement as video content, in conjunction with video content, and/or displaying a banner advertisement with the broadcast video content. Further, an advertisement can be displayed with a selectable control which, when selected, initiates that information corresponding to a rendered advertisement is stored in an advertisement data store.

At block 604, it is determined that an advertisement has been displayed. For example, advertisement component 338 in client device 108 determines that an advertisement has been processed by content processor 326 for display on television 128. Similarly, advertisement component 402 in content provider 102 determines from information communicated by client device 108 that an advertisement has been processed by content processor 326 for display.

At block 606, a request is received to store information corresponding to a rendered advertisement in the advertisement data store. For example, when a selectable control of an interactive advertisement is selected, advertisement component 338 receives the control selection as a request to store advertisement information in advertisement data store 302. Examples of information corresponding to a rendered advertisement can include a video commercial, banner advertisement, still image, an interactive advertisement, as well as the advertisement itself.

At block 608, advertisement information is received that corresponds to a displayed advertisement, and at block 610, the advertisement information is stored in the advertisement data store. For example, advertisement component 402 receives information that corresponds to a displayed advertisement from advertiser 418(1) and stores the advertisement information 404 in advertisement data store 302. Advertisement component 402 communicates the advertisement information to the advertisement data store 302 where the information is maintained for viewing, future reference, and/or availability.

Storing advertisement information 404 includes communicating video and/or audio content to the advertisement data store and maintaining the video and/or audio content. Further, storing the information corresponding to a rendered advertisement can include maintaining an interactive advertisement which links the rendered advertisement to an advertiser having additional information corresponding to the rendered advertisement.

At block 612, a request is received to login to the advertisement data store, and at block 614, the information stored in the advertisement data store is displayed for viewer-reference. For example, advertisement component 338 can receive a login request from a viewer to review advertisement information maintained in advertisement data store 302. Further, a user interface application, such as one of application programs 322 in client device 108, generates graphical user interface 500 which displays the advertisement information stored in advertisement data store 302.

At block 616, the advertisement information stored in the advertisement data store is categorized. For example, advertisement component 338 can categorize the advertisement information by the type of product advertised, by the type of service advertised, by the most recently rendered advertisements, by viewer-defined selections, and/or by a viewer profile (such as when a viewer logs into view the information in the advertisement data store at block 612).

At block 618, the information stored in the advertisement data store corresponding to one or more rendered advertisements is tracked, or otherwise logged, when selected for review. For example, advertisement component 402 tracks which advertisement information 404 is reviewed. At block 620, the advertisement information stored in the advertisement data store is managed. For example, content provider 102 includes advertisement data store tools 422 that can be implemented as automated and/or interactive tools to manage the advertisement information 404 in the advertisement data store 302. The advertisement data store tools 422 can include such tools to categorize the advertisement information, edit associated metadata, and graphics tools to generate an advertisement and specify the metadata.

At block 622, the information stored in the advertisement data store corresponding to one or more of the rendered advertisements is deleted from the advertisement data store after a defined duration. An advertisement can be deleted from the advertisement data store after a system default time, such as after one-week, or can be deleted based on hard disk space availability such as in a digital video recording system. For example, a portion of the hard disk in a digital video recorder can be allocated for advertisement data storage, and once full, advertisements can be deleted based on a first-in, first-out policy, a stored favorites policy, and/or on any number of other storage management schemes. A storage management scheme can include generating revenue by maintaining the advertisements of advertisers that have paid to have their advertisement information stored for a longer period of time.

### CONCLUSION

Although the invention has been described in language specific to structural features and/or methods, it is to be understood that the invention defined in the appended claims is not necessarily limited to the specific features or methods described. Rather, the specific features and methods are disclosed as preferred forms of implementing the claimed invention.

1. An interactive television system, comprising:
a content processor configured to communicate video content for display;
an advertisement data store configured to maintain information corresponding to one or more advertisements having been displayed; and
an advertisement component configured to communicate the information corresponding to a displayed advertisement to the advertisement data store.

2. An interactive television system as recited in claim 1, further comprising a graphical user interface configured to display the information maintained in the advertisement data store for viewer-reference.

3. An interactive television system as recited in claim 1, wherein the content processor is further configured to communicate the one or more advertisements for display.

4. An interactive television system as recited in claim 1, wherein the content processor is further configured to communicate the one or more advertisements for display as banner advertisements in conjunction with the video content.

5. An interactive television system as recited in claim 1, wherein the content processor is further configured to communicate the one or more advertisements for display, a displayed advertisement including a selectable control which, when selected, initiates information corresponding to the displayed advertisement being stored in the advertisement data store.

6. An interactive television system as recited in claim 1, wherein the advertisement data store is further configured to maintain at least one of video content and audio content corresponding to a displayed advertisement.

7. An interactive television system as recited in claim 1, wherein the advertisement data store is further configured to maintain the one or more advertisements having been displayed.

8. An interactive television system as recited in claim 1, wherein the advertisement data store is further configured to maintain an interactive advertisement that links a displayed advertisement to an advertiser's additional information corresponding to the displayed advertisement.

9. An interactive television system as recited in claim 1, wherein the advertisement data store is further configured to maintain a selectable link to additional information corresponding to a displayed advertisement.

10. An interactive television system as recited in claim 1, wherein the advertisement data store is further configured to maintain a selectable link to an advertiser's additional information corresponding to a displayed advertisement.

11. An interactive television system as recited in claim 1, wherein the advertisement component is further configured to categorize the information maintained in the advertisement data store by at least one of the type of product advertised and the type of service advertised.

12. An interactive television system as recited in claim 1, wherein the advertisement component is further configured to categorize the information maintained in the advertisement data store by the most recently displayed advertisements.

13. An interactive television system as recited in claim 1, wherein the advertisement component is further configured to categorize the information maintained in the advertisement data store by viewer-defined selections.

14. An interactive television system as recited in claim 1, wherein the advertisement component is further configured to categorize the information maintained in the advertisement data store by a viewer profile.

15. An interactive television system as recited in claim 1, wherein the advertisement component is further configured to receive a request to store information corresponding to a displayed advertisement in the advertisement data store, and categorize requested information corresponding to displayed advertisements as viewer-defined selections.

16. An interactive television system as recited in claim 1, wherein the advertisement component is further configured to receive a request to login to the advertisement data store, and categorize the information stored in the advertisement data store by a viewer profile.

17. An interactive television system as recited in claim 1, wherein the advertisement component is further configured to track which information corresponding to the one or more displayed advertisements is selected for review.

18. An interactive television system as recited in claim 1, wherein the advertisement component is further configured to delete the information corresponding to one or more of the displayed advertisements from the advertisement data store after a defined duration.

19. An interactive television system as recited in claim 1, further comprising an information management component configured to manage the information maintained in the advertisement data store.

20. An interactive television system as recited in claim 1, further comprising a video content provider configured to provide the video content, and further configured to manage the information maintained in the advertisement data store with an information management tools.

21. A content provider comprising the interactive television system as recited in claim 1.

22. A digital video recorder comprising the interactive television system as recited in claim 1.

23. A method, comprising:
rendering advertisements for viewing on a display device; and
storing information corresponding to one or more of the rendered advertisements in an advertisement data store.

24. A method as recited in claim 23, wherein rendering the advertisements includes displaying an advertisement in conjunction with video content.

25. A method as recited in claim 23, wherein rendering the advertisements includes displaying a banner advertisement in conjunction with video content.

26. A method as recited in claim 23, wherein rendering the advertisements includes displaying an advertisement with a selectable control which, when selected, initiates information corresponding to the rendered advertisement being stored in the advertisement data store.

27. A method as recited in claim 23, wherein storing the information corresponding to a rendered advertisement includes communicating the rendered advertisement to the advertisement data store and maintaining the rendered advertisement for viewing.

28. A method as recited in claim 23, further comprising receiving a user input to store a rendered advertisement and storing the rendered advertisement in the advertisement data store for later viewing by the user.

29. A method as recited in claim 23, wherein storing the information corresponding to a rendered advertisement includes communicating at least one of video content and audio content corresponding to the rendered advertisement and maintaining at least one of the video content and audio content for availability.

30. A method as recited in claim 23, wherein storing the information corresponding to a rendered advertisement includes maintaining an interactive advertisement that links the rendered advertisement to an advertiser's additional information corresponding to the rendered advertisement.

31. A method as recited in claim 23, wherein storing the information corresponding to a rendered advertisement includes maintaining a selectable link to additional information corresponding to the rendered advertisement.

32. A method as recited in claim 23, wherein storing the information corresponding to a rendered advertisement includes maintaining a selectable link to an advertiser's additional information corresponding to the rendered advertisement.

33. A method as recited in claim 23, further comprising displaying the information stored in the advertisement data store for viewer-reference.

34. A method as recited in claim 23, further comprising categorizing the information stored in the advertisement data store by at least one of the type of product advertised and the type of service advertised.

35. A method as recited in claim 23, further comprising categorizing the information stored in the advertisement data store by the most recently rendered advertisements.

36. A method as recited in claim 23, further comprising categorizing the information stored in the advertisement data store by viewer-defined selections.

37. A method as recited in claim 23, further comprising categorizing the information stored in the advertisement data store by a viewer profile.

38. A method as recited in claim 23, further comprising receiving a request to store information corresponding to a rendered advertisement in the advertisement data store, and categorizing requested information corresponding to rendered advertisements as viewer-defined selections.

39. A method as recited in claim 23, further comprising receiving a request to login to the advertisement data store, and categorizing the information stored in the advertisement data store by a viewer profile.

40. A method as recited in claim 23, further comprising tracking which information corresponding to the one or more rendered advertisements is selected for review.

41. A method as recited in claim 23, further comprising managing the information stored in the advertisement data store.

42. A method as recited in claim 23, further comprising deleting the information corresponding to one or more of the rendered advertisements from the advertisement data store after a defined duration.

43. One or more computer-readable media comprising computer-executable instructions that, when executed, direct a client device to perform the method of claim 23.

44. A digital video recording system, comprising:
means for displaying advertisements on a display device; and
means for storing information corresponding to one or more of the displayed advertisements in an advertisement data store.

45. A digital video recording system as recited in claim 44, further comprising means for maintaining as the information corresponding to the one or more displayed advertisements at least one of video content, audio content, and an interactive advertisement in the advertisement data store.

46. A digital video recording system as recited in claim 44, further comprising means for displaying the information stored in the advertisement data store.

47. A digital video recording system as recited in claim 44, further comprising means for categorizing the information stored in the advertisement data store.

48. A digital video recording system as recited in claim 44, further comprising means for tracking which information corresponding to the one or more displayed advertisements is selected for review.

49. A digital video recording system as recited in claim 44, further comprising means for managing the information stored in the advertisement data store.

50. A client device, comprising:
one or more processors;
a content processor configured to:
execute on the one or more processors;
communicate video content for display; and
communicate advertisements for display;
an advertisement component configured to:
execute on the one or more processors; and
communicate that an advertisement has been displayed to an
advertising service that then stores information corresponding to the advertisement in an advertisement data store.

51. A client device as recited in claim 50, wherein the content processor is further configured to communicate an interactive advertisement for display that includes a selectable control which, when selected, initiates that the advertisement component communicate with the advertising service to store information corresponding to the interactive advertisement in the advertisement data store.

52. A client device as recited in claim 50, further comprising a graphical user interface configured to display the information stored in the advertisement data store for viewer-reference.

53. A client device as recited in claim 52, wherein the graphical user interface includes a selectable control that, when selected, initiates the advertisement being displayed.

54. A client device as recited in claim 52, wherein the graphical user interface includes a selectable control that, when selected, initiates video content corresponding to the advertisement being displayed.

55. A client device as recited in claim 52, wherein the graphical user interface includes a selectable control that, when selected, initiates audio content corresponding to the advertisement being rendered.

56. A client device as recited in claim 52, wherein the graphical user interface includes a selectable control that, when selected, initiates audio content corresponding to the advertisement being rendered.

57. A client device as recited in claim 52, wherein the graphical user interface includes a selectable control that, when selected, links to additional information corresponding to the advertisement.

58. A client device as recited in claim 52, wherein the advertisement component is further configured to categorize the information displayed as part of the graphical user interface by at least one of the type of product advertised and the type of service advertised.

59. A client device as recited in claim 52, wherein the advertisement component is further configured to categorize the information displayed as part of the graphical user interface by the most recently displayed advertisements.

60. A client device as recited in claim 52, wherein the advertisement component is further configured to categorize the information displayed as part of the graphical user interface by viewer-defined selections.

61. A client device as recited in claim 52, wherein the advertisement component is further configured to categorize the information displayed as part of the graphical user interface by a viewer profile.

62. A digital video recorder comprising the client device as recited in claim 50.

63. One or more computer-readable media comprising computer executable instructions that, when executed, direct an advertisement component to:
determine that an advertisement has been displayed;
receive information corresponding to the displayed advertisement; and
store the information in an advertisement data store.

64. One or more computer-readable media as recited in claim 63, further comprising computer executable instructions that, when executed, direct the advertisement component to receive a request to store the information corresponding to the displayed advertisement in the advertisement data store.

65. One or more computer-readable media as recited in claim 63, further comprising computer executable instructions that, when executed, direct the advertisement component to receive at least one of video content and audio content corresponding to the displayed advertisement, and store the at least one of video content and audio content in the advertisement data store.

66. One or more computer-readable media as recited in claim 63 further comprising computer executable instructions that, when executed, direct the advertisement component to receive an interactive advertisement that links to additional information corresponding to the displayed advertisement.

67. One or more computer-readable media as recited in claim 63, further comprising computer executable instructions that, when executed, direct the advertisement component to categorize the information maintained in the advertisement data store by at least one of the type of product advertised and the type of service advertised.

68. One or more computer-readable media as recited in claim 63, further comprising computer executable instructions that, when executed, direct the advertisement component to categorize the information maintained in the advertisement data store by the most recently displayed advertisements.

69. One or more computer-readable media as recited in claim 63, further comprising computer executable instructions that, when executed, direct the advertisement component to categorize the information maintained in the advertisement data store by viewer-defined selections.

70. One or more computer-readable media as recited in claim 63, further comprising computer executable instructions that, when executed, direct the advertisement component to track which information corresponding to one or more displayed advertisements is selected for review in the advertisement data store.

71. One or more computer-readable media as recited in claim 63, further comprising computer executable instructions that, when executed, direct the advertisement component to delete the information corresponding to the displayed advertisement from the advertisement data store after a defined duration.
